(19) United States
(12) Patent Application Publication
(10) Pub. No.: US 2025/0055506 A1
(43) Pub. Date: Feb. 13, 2025

(54) SOUNDING REFRENCE SIGNAL (SRS) BASED BEAM PAIR SELECTION FOR SIMULTANEOUS UPLINK TRANSMISSION WITH MULTI-PANEL (STxMP)

(71) Applicant: Apple Inc., Cupertino, CA (US)

(72) Inventors: Xiang CHEN, Campbell, CA (US); Yang TANG, San Jose, CA (US); Qiming LI, Beijing (CN); Haitong SUN, Cupertino, CA (US); Jie CUI, San Jose, CA (US); Manasa RAGHAVAN, Sunnyvale, CA (US); Dawei ZHANG, Saratoga, CA (US)

(73) Assignee: Apple Inc., Cupertino, CA (US)

(21) Appl. No.: 18/764,625

(22) Filed: Jul. 5, 2024

Related U.S. Application Data
(60) Provisional application No. 63/531,482, filed on Aug. 8, 2023.

(51) Int. Cl. H04B 7/0408; H04B 7/0404; H04B 7/06; H04L 5/00

(52) U.S. Cl. CPC H04B 7/0408; H04B 7/0404; H04B 7/0696; H04L 5/0051

(57) ABSTRACT

A user equipment (UE) and a network node can support sounding reference signals (SRS) based antenna beam pair selection for simultaneous uplink transmission with multi-panels by the UE. One or more antenna beam pairs of a UE having a first antenna panel and a second antenna panel may be used to transmit SRSs to a first transmission reception point (TRP) and a second TRP simultaneously using SRS resources configured by one or more SRS configuration sets from the network node. The UE can configure a SRS spatial filter for a SRS resource to indicate a direction of an antenna beam, while some of the SRS resource is configured by the one or more SRS configuration sets received from the network node. The network node can select an antenna beam pair among the one or more antenna beam pairs based on indications of signal strength of SRSs received.

### RELATED APPLICATIONS

This application claims benefit of U.S. Provisional Patent Application No. 63/531,482 filed Aug. 8, 2023, the content of which is herein incorporated by reference in its entirety.

### BACKGROUND

### Field

The described aspects generally relate to sounding reference signals (SRS) based beam pair selection.

### Related Art

A user equipment (UE) communicates with a base station, such as an evolved Node B (eNB), a next generation node B (gNB), a transmission reception point (TRP), a network node, or other base station, in a wireless communication network or system. A wireless communication system can include a fifth generation (5G) system, a New Radio (NR) system, a long term evolution (LTE) system, a combination thereof, or some other wireless systems. In addition, a wireless communication system can support a wide range of use cases such as enhanced mobile broad band (eMBB), massive machine type communications (mMTC), ultra-reliable and low-latency communications (URLLC), and enhanced vehicle to anything communications (eV2X). There are challenges in various technologies such as a NR wireless system.

### SUMMARY

Some aspects of this disclosure relate to apparatuses and methods for implementing techniques for a user equipment (UE) or a network node to support sounding reference signals (SRS) based antenna beam pair selection for simultaneous uplink transmission with multi-panels (STxMP) by a UE. One or more antenna beam pairs of a UE having a first antenna panel and a second antenna panel may be used to transmit SRSs to a first transmission reception point (TRP) and a second TRP simultaneously using SRS resources configured by one or more SRS configuration sets from the network node. However, a SRS spatial filter for a SRS resource to indicate a direction of an antenna beam used to transmit a SRS can be configured by the UE, while some or the rest components of the SRS resource can be configured by the one or more SRS configuration sets received from the network node. The network node can select an antenna beam pair for further data transmission between the UE and two TRPs, where the selected antenna beam pair is selected from the one or more antenna beam pairs based on indications of measured signal strength of SRSs transmitted by the one or more antenna beam pairs. The implemented techniques can be applicable to many wireless systems, e.g., a wireless communication system based on 3rd Generation Partnership Project (3GPP) release 15 (Rel-15), release 16 (Rel-16), release 17 (Rel-17), release 18 (Rel-18), or beyond.

Some aspects of this disclosure relate to a UE. The UE may include a transceiver and a processor communicatively coupled to the transceiver. The transceiver can be coupled to a first antenna panel and a second antenna panel configured to enable wireless communication with two TRPs and a network node in a wireless communication system. The processor can receive one or more SRS configuration sets from the network node, where the one or more SRS configuration sets include configurations for SRS resources for one or more antenna beam pairs. An antenna beam pair can include a first beam of the first antenna panel and a second beam of the second antenna panel of the UE.

In some embodiments, the processor can select directions for antenna beams of the one or more antenna beam pairs of the UE. The configurations for the SRS resources can include a first SRS resource and a second SRS resource used for a first beam and a second beam respectively. The processor can configure a first SRS spatial filter for the first SRS resource to determine a first direction of the first beam, and a second SRS spatial filter for the second SRS resource to determine a second direction of the second beam.

In some embodiments, the one or more SRS configuration sets can include one or more parameters including a SRS-ResourceSet, and a SRS spatial filter can be associated with a parameter spatialRelationInfo included within the SRS-ResourceSet. In some embodiments, the UE may receive a SRS-ResourceSet having the parameter spatialRelationInfo not configured by the network node, and the UE can decide its beam direction of SRS transmission by choosing a spatial filter for the parameter spatialRelationInfo. In some other embodiments, the UE can change the parameter spatialRelationInfo from a first value to a second value to configure the SRS spatial filter. In some embodiments, the first SRS spatial filter for the first SRS resource or the second SRS spatial filter for the second SRS resource can be associated with a parameter included in the one or more SRS configuration sets. The UE can add the parameter or change the parameter from a first value to a second value to configure the first SRS spatial filter. In some embodiments, the SRS resources for the one or more antenna beam pairs can be included in one SRS configuration set determined by the network node.

In some embodiments, the processor can determine the first SRS resource for the first beam from a first group of SRS resources configured by a SRS configuration set received from the network node, and determine the second SRS resource for the second beam from a second group of SRS resources configured by the same SRS configuration set, where the first group of SRS resources is different from the second group of SRS resources. In some embodiments, the processor can determine the first SRS resource for the first beam configured by a first SRS configuration set received from the network node, and determine the second SRS resource for the second beam configured by a second SRS configuration set received from the network node, where the first SRS configuration set is different from the second SRS configuration set. In addition, the first SRS configuration set and the second SRS configuration set can be configured for a same uplink transmission usage.

In some embodiments, the processor can transmit simultaneously a first SRS over the first SRS resource using the first beam in the first direction to a first TRP, and a second SRS over the second SRS resource using the second beam in the second direction to a second TRP. In addition, the processor can transmit SRSs by the one or more antenna beam pairs to the first TRP and the second TRP respectively.

In some embodiments, the processor can receive an indication of a selected antenna beam pair from the network node, where the selected antenna beam pair can be selected by the network node based on measured signal strength represented by Reference Signal Received Power (RSRP) or Signal to Interference plus Noise Ratio (SINR) for the SRSs transmitted by the one or more antenna beam pairs. Afterwards, the processor can transmit data through Physical Uplink Shared Channel (PUSCH) by the selected antenna beam pair to the first TRP and the second TRP simultaneously.

In some embodiments, the processor can determine an updated antenna beam pair to replace the selected antenna beam pair for transmitting data through PUSCH by the updated antenna beam pair to the first TRP and the second TRP simultaneously. In some embodiments, the processor can receive a message from the network node to instruct the UE to determine the updated antenna beam pair, where the message is received after a timer maintained by the network node is expired. In some embodiments, the processor can initiate a beam pair update process by sending an update message to the network node, where the update message includes a uplink control information (UCI) or a medium access control (MAC) control element (MAC-CE) message.

Some aspects of this disclosure relate to a network node. The network node can include a transceiver and a processor communicatively coupled to the transceiver. The transceiver can be configured to enable wireless communication with two TRPs and a UE in a wireless communication system, where the UE has a transceiver coupled to a first antenna panel and a second antenna panel. The processor can generate a number of SRS configuration sets that includes configurations for SRS resources for one or more antenna beam pairs, where an antenna beam pair includes a first beam of the first antenna panel and a second beam of the second antenna panel of the UE. The configurations for the SRS resources for the one or more antenna beam pairs can include a first configuration of a first SRS resource for the first beam without configuring a first SRS spatial filter for the first SRS resource indicating a first direction of the first beam, and a second configuration of a second SRS resource for the second beam without configuring a second SRS spatial filter for the second SRS resource indicating a second direction of the second beam.

In some embodiments, the processor can transmit the number of SRS configuration sets to the UE, and receive indications of measured signal strength of SRSs transmitted by the one or more antenna beam pairs received by the first TRP and the second TRP. The indications of measured signal strength of SRSs can include a first signal strength indication for a first SRS received by the first TRP transmitted over the first SRS resource using the first beam in the first direction determined by the first SRS spatial filter that is configured by the UE, and a second signal strength indication for a second SRS received by the second TRP transmitted over the second SRS resource using the second beam in the second direction determined by the second SRS spatial filter that is configured by the UE. The first SRS and the second SRS are transmitted simultaneously to the first TRP and the second TRP respectively.

In some embodiments, the processor can select an antenna beam pair from the one or more antenna beam pairs based on the indications of measured signal strength of SRSs, where the first signal strength indication or the second signal strength indication can be represented by RSRP or SINR.

In some embodiments, to determine the selected antenna beam pair, the processor can determine whether the first signal strength indication or the second signal strength indication is larger than a first predetermined threshold value of measured signal strength, determine whether a difference between the first signal strength indication and the second signal strength indication is smaller than a second predetermined threshold value, and further determine the selected antenna beam pair from the one or more antenna beam pairs based on a ranking of the indications of measured signal strength of SRSs for the one or more antenna beam pairs.

In some embodiments, the processor can determine an updated antenna beam pair to replace the selected antenna beam pair for transmitting data through PUSCH by the updated antenna beam pair to the first TRP and the second TRP simultaneously.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example wireless system supporting sounding reference signals (SRS) based beam pair selection for simultaneous uplink transmission with multi-panel (STxMP), according to some aspects of the disclosure.

FIGS. 2A-2B illustrate a block diagram of a UE and a network node implementing SRS based beam pair selection for STxMP, according to some aspects of the disclosure.

FIGS. 3A-3B illustrate an example processes performed by a UE and a network node supporting SRS based beam pair selection for STxMP, according to some aspects of the disclosure.

FIG. 4 is an example computer system for implementing some aspects or portion(s) thereof of the disclosure provided herein.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

In a wireless system, multiple input-multiple output (MIMO) transmission is an important technology. A user equipment (UE) or a base station can include an antenna array or system having a plurality of antenna panels coupled to antenna ports, where an antenna panel can include an array of antenna elements that can be located in close physical location to each other. In some examples, an antenna can be a smart antenna system, where all antenna elements are considered as pseudo-omni or quasi-sector-omni antenna elements including a phase shifter. An antenna beam, such as a transmission (Tx) beam or a receiving (Rx) beam, can be a directional beam formed by adjusting the phase shifters of multiple antenna elements. For descriptions herein, an antenna beam may be referred to as a beam as well.

In some embodiments, at a time instance, among multiple antenna panels, a UE may have only one antenna panel activated and used for uplink transmission. In order to improve the reliability and robustness, uplink multi-panel transmission enhancements on multi-beam operations can be developed. In some embodiments, multiple antenna panels on a UE can be activated at a same time and used for simultaneous transmissions to multiple transmission reception points (TRPs) or base stations, leading to simultaneous transmission with multi-panel (STxMP). In some embodiments, to enable simultaneous transmission by multi-panels in the uplink, a UE may select one beam from each antenna panel. For a UE with two antenna panels to perform simultaneous transmissions to two different TRPs, the two beams selected from the two panels to communicate with two TRPs or base stations for simultaneous transmissions can form an antenna beam pair. A UE may have multiple antenna beam pairs that can be used to perform STxMP, hence a mechanism can be used to select an antenna beam pair from one or more antenna beam pairs available to improve the performance.

Embodiments herein may present techniques for beam pair selection from one or more antenna beam pairs available based on sounding reference signals (SRS) for STxMP by a UE. SRS can be transmitted by the UE on the uplink to allow the network to estimate the quality of the channel. A SRS resource can occupy a specific location in the time and frequency domain in a resource grid to transmit SRS. The UE may be configured with one or more SRS resources by a higher layer parameter SRS-ResourceSet, which can be contained in a Radio Resource Control (RRC) message. A Tx beam for uplink channels such as SRS, Physical Uplink Control Channel (PUCCH), and Physical Uplink Shared Channel (PUSCH) may be indicated by a SpatialRelationInfo parameter, or a parameter related to a SRS spatial filter for the UE.

Embodiments herein present techniques for a UE to report uplink beam pairs for STxMP from the UE. One or more antenna beam pairs of a UE having a first antenna panel and a second antenna panel may be used to transmit SRSs to a first TRP and a second TRP simultaneously using SRS resources configured by one or more SRS configuration sets from the network node. However, the UE configures a SRS spatial filter for a SRS resource to determine a direction of an antenna beam used to transmit a corresponding SRS, while some or the rest components of the SRS resource are configured by the one or more SRS configuration sets received from the network node. The network node can select an antenna beam pair for further data transmission between the UE and two TRPs, where the selected antenna beam pair is selected from the one or more antenna beam pairs based on indications of measured signal strength of SRSs transmitted by the one or more antenna beam pairs.

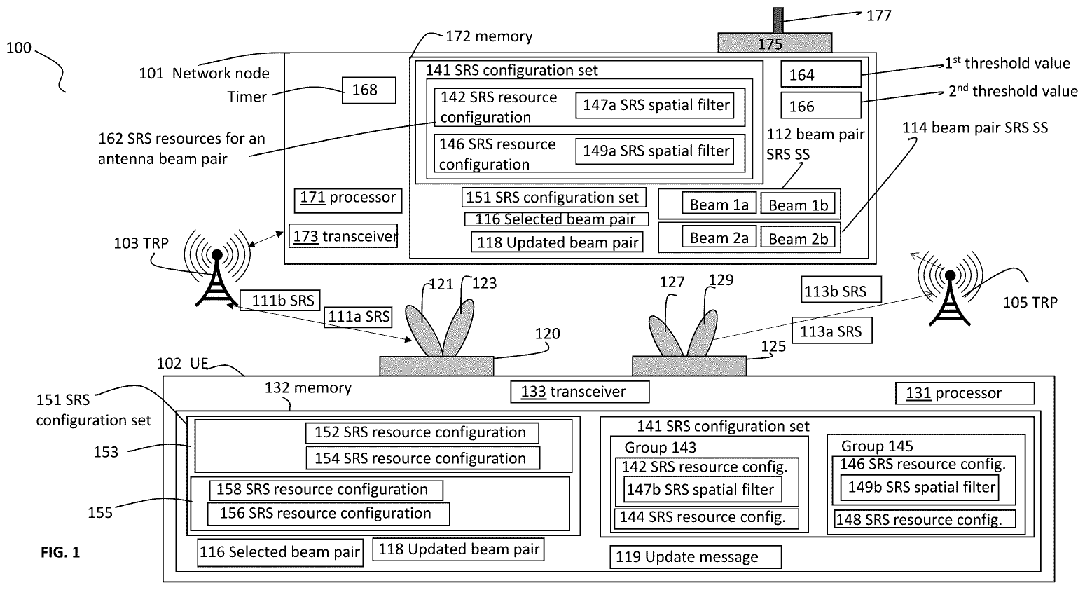

FIG. 1 illustrates an example wireless system 100 supporting sounding reference signals (SRS) based beam pair selection for STxMP, according to some aspects of the disclosure. The wireless system 100 is provided for the purpose of illustration only and does not limit the disclosed aspects. As shown in FIG. 1, system 100 can include, but is not limited to, a network node 101, a TRP 103, a TRP 105, all communicating with a UE 102. System 100 can further include additional components, not shown.

In some examples, wireless system 100 can be a NR system, a LTE system, a 5G system, or some other wireless system. In addition, wireless system 100 can support a wide range of use cases such as enhanced mobile broad band (eMBB), massive machine type communications (mMTC), ultra-reliable and low-latency communications (URLLC), and enhanced vehicle to anything communications (eV2X).

According to some aspects, network node 101, TRP 103, or TRP 105 can collectively operate together as a network node controlled by network node 101, and configured to operate based on a wide variety of wireless communication techniques such as, but not limited to, techniques based on 3rd Generation Partnership Project (3GPP) standards. For example, network node 101, TRP 103, or TRP 105 can collectively operate as a node configured to operate using Rel-16, Rel-17, or others. Network node 101, TRP 103, or TRP 105 can, in combination or individually, be a fixed station, and may also be called a base transceiver system (BTS), an access point (AP), an evolved NodeB (eNB), a next generation node B (gNB), or some other equivalent terminology. The system 100 can operate using both licensed cellular spectrum (known as in-band communication) and unlicensed spectrum (known as out-band communication).

According to some aspects, network node 101, TRP 103, or TRP 105 can provide wireless coverage of cells of various sizes, such as a macro cell, a pico cell, a femto cell, and/or another type of cell. For comparison, a macro cell can cover a relatively large geographic area, e.g., several kilometers in radius, a femto cell can cover a relatively small geographic area, e.g., a home, while a pico cell covers an area smaller than the area covered by a macro cell but larger than the area covered by a femto cell. For example, network node 101 can cover a macro cell, while TRP 103 and TRP 105 can cover a pico cell or a femto cell. In addition, network node 101 can cover a pico cell, while TRP 103 and TRP 105 can cover a femto cell. In some examples, the geographic area of a cell can move according to the location of a mobile base station. In some embodiments, network node 101 can be implemented as a part of the core network instead of a base station. In some embodiments, network node 101, TRP 103 and TRP 105 can implement techniques for carrier aggregation, where TRP 103 and TRP 105 can operate on different component carriers, such as a first component carrier (CC) and a second component carrier. In some embodiments, the first CC can be in a first frequency range (FR1), and the second CC can be in a second frequency range (FR2). In some other embodiments, the first CC and the second CC can be in a same frequency range. In some embodiments, TRP 103 and TRP 105 can be coupled to network node 101 by wireless communication links, or by any backhaul connections.

According to some aspects, UE 102 can be configured to operate based on a wide variety of wireless communication techniques. These techniques can include, but are not limited to, techniques based on 3GPP standards. For example, UE 102 can be configured to operate using Rel-16, Rel-17 or later. UE 102 can include, but is not limited to, a wireless communication device, a smart phone, a laptop, a desktop, a tablet, a personal assistant, a monitor, a television, a wearable device, an Internet of Things (IoTs), a vehicle's communication device, a mobile station, a subscriber station, a remote terminal, a wireless terminal, a user device, or the like.

According to some aspects, UE 102 can include an antenna array or system having a plurality of antenna panels, such as an antenna panel 120 and an antenna panel 125. In general, an antenna system can include one or more antenna panels. An antenna panel can include an array of antenna elements that can be located in close physical location to each other. An antenna element can be an omnidirectional antenna element, a quasi-omnidirectional antenna element, a directional antenna element, or any other antenna element. In some examples, an antenna panel can be a smart antenna system, where all antenna elements are considered as pseudo-omni or quasi-sector-omni antenna elements and include a phase shifter. A directional beam, such as a transmission (Tx) beam or a receiving (Rx) beam, can be formed by adjusting the phase shifters of multiple antenna elements. For example, antenna panel 120 can provide beam 121 and beam 123, and antenna panel 125 can provide beam 127 and beam 129. In some examples, there can be more or fewer antenna panels, and an antenna panel can include 2, 4, 8, 16, or other number of antenna elements, which can include a dipole antenna element, a monopole antenna element, a patch antenna element, a loop antenna element, a microstrip antenna element, or any other type of antenna elements suitable for transmission of RF signals.

According to some aspects, UE 102 can include a transceiver 133 coupled to antenna panel 120 and antenna panel 125, a processor 131, and a memory 132 communicatively coupled to transceiver 133. Transceiver 133 can enable wireless communication with network node 101, TRP 103 and TRP 105 using antenna beam pairs formed by antenna panel 120 and antenna panel 125. For example, UE 102 can communicate with TRP 103 and TRP 105 using an antenna beam pair including a first beam of the first antenna panel 120 and a second beam of the second antenna panel 125, such as an antenna beam pair (beam 121, beam 127), (beam 121, beam 129), (beam 123, beam 127), or (beam 123, beam 129).

In some embodiments, processor 131 can receive one or more SRS configuration sets from network node 101, such as a SRS configuration set 141, a SRS configuration set 151, or both. SRS configuration set 141 includes configurations for SRS resources for one or more antenna beam pairs, such as a configuration for SRS resource 142, which can be referred to as SRS resource configuration 142, that can be used for a first beam such as beam 121, and a configuration for SRS resource 146, which can be referred to as SRS resource configuration 146, that can be used for a second beam such as beam 127. When SRS configuration set 141 is generated by network node 101, SRS resource configuration 142 may contain a parameter SRS-SpatialRelationInfo. If SRS-SpatialRelationInfo is configured, UE 102 will use the corresponding spatial filter configured by SRS-SpatialRelationInfo. If SRS-SpatialRelationInfo is not configured, UE 102 will choose a spatial filter on its own. In some embodiments, spatialRelationInfo is not configured when resource configuration 142 does not include the IE spatialRelationInfo. In some embodiments, SRS resource configuration 142 can include a (blank) SRS spatial filter 147a that is not configured by network node 101. For example, the SRS spatial filter 147a has as an unassigned parameter without an assigned value or is assigned with a placeholder value that is meant to be changed by the UE. Similarly, SRS resource configuration 146 can include a SRS spatial filter 149a that is not configured by network node 101, e.g., has as an unassigned parameter as discussed above. UE 102 can select a first direction for antenna beam 121, and further configure SRS spatial filter 147a received from network node 101 to become SRS spatial filter 147b to implement the first direction for beam 121. Configuring SRS spatial filter 147b may be performed by assigning a value to the unassigned parameter of SRS spatial filter 147a to have a new value that is different from the value of SRS spatial filter 147a. Similarly, UE 102 can select a second direction for antenna beam 127, and further configure SRS spatial filter 149a received from network node 101 to become SRS spatial filter 149b having a different from the value of SRS spatial filter 149a to implement the second direction for beam 127.

In some embodiments, the one or more SRS configuration sets, such as SRS configuration set 141 or SRS configuration set 151, can be indicated by one or more parameters including a SRS-ResourceSet. In some embodiments, SRS-ResourceSet can be a record including various components, such as “SRS-Resources,” “SRS resource set identifier,” “SRS resourceType,” and more. For example, “SRS-Resources” can be configured or set to BeamManagement, semi-static, semi-persistent, aperiodic, or periodic, by higher layer parameter SRS called “Resourcetype”. Accordingly, a SRS spatial filter, such as SRS spatial filter 147a, SRS spatial filter 149a, SRS spatial filter 147b, or SRS spatial filter 149b, can be indicated by a parameter spatialRelationInfo included within the SRS-ResourceSet and configured by the UE. When SRS configuration set 141 is generated by network node 101 and represented by parameter SRS-ResourceSet, which is a record that includes a field spatialRelationInfo representing a SRS spatial filter, spatialRelationInfo may not have an assigned value when being generated. UE 102 can receive SRS configuration set 141 and further assign a value to spatialRelationInfo to configure spatialRelationInfo and indicate a direction of beam 121.

In some embodiments, SRS spatial filter for the first SRS resource, such as SRS spatial filter 147a, or SRS spatial filter for the second SRS resource, such as SRS spatial filter 149a, can be a parameter included in the one or more SRS configuration sets, such as SRS configuration set 141. In some embodiments, SRS spatial filter for the first SRS resource, such as SRS spatial filter 147a, or SRS spatial filter for the second SRS resource, such as SRS spatial filter 149a, can be configured only by UE 102. In some embodiments, SRS spatial filter 147a or SRS spatial filter 149a can have a placeholder value assigned by network node 101, which can be overwritten by UE 102. In some embodiments, if UE 102 overwrites a value of SRS spatial filter 147a or SRS spatial filter 149a configured by network node 101, then UE re-configures SRS spatial filter 147a to be SPS spatial filter 147b and/or re-configures SRS spatial filter 149a to be SRS spatial filter 149b.

In some embodiments, UE 102 may receive only one SRS configuration set, such as SRS configuration set 151. In some embodiments, SRS configuration set 151 can include multiple pairs of SRS resources for multiple beam pairs of UE 101. For example, SRS configuration set 151 can include a SRS resource pair 153 containing a SRS resource configured by SRS resource configuration 152 for a first beam such as beam 121, and a SRS resource configured by SRS resource configuration 154 for a second beam such as beam 127. In addition, SRS configuration set 151 can include a SRS resource pair 155 containing a SRS resource configured by SRS resource configuration 156 for a first beam such as beam 121, and a SRS resource configured by SRS resource configuration 158 for a second beam such as beam 129.

In some embodiments, UE 102 may receive only one SRS configuration set, such as SRS configuration set 141. SRS resources configured by SRS configuration set 141 can be divided into two groups, such as a group 143 and a group 145. Group 143 can include an SRS resource configured by SRS resource configuration 142 and an SRS resource configured by SRS resource configuration 144. While group 145 can include an SRS resource configured by SRS resource configuration 146 and an SRS resource configured by SRS resource configuration 148. For a beam pair (beam 121, beam 127), processor 131 can select a first SRS resource for the first beam, e.g., beam 121, from group 143 of SRS resources configured by SRS configuration set 141 received from network node 101, and select a second SRS resource for the second beam, e.g., beam 127, from group 145 of SRS resources configured by the same SRS configuration set 141, where the first group of SRS resources is different from the second group of SRS resources.

In some embodiments, processor 131 can select the first SRS resource, e.g., SRS resource configured by SRS resource configuration 142, for the first beam, e.g., beam 121, configured by SRS configuration set 141, and select the second SRS resource, e.g., SRS resource configured by SRS resource configuration 152, for the second beam, e.g., beam 129, configured by SRS configuration set 151 different from SRS configuration set 141. In some embodiments, SRS configuration set 141 and SRS configuration set 151 can be configured for a same uplink transmission usage, such as being configured to have the same values for parameters such as “beamManagement”, “codebook” or “nonCodebook” for SRS-ResourceSct.

In some embodiments, processor 131 can transmit simultaneously a SRS 111a by a first SRS resource, e.g., SRS resource configured by SRS resource configuration 142, using beam 121 in a first direction to TRP 103, and transmit a SRS 113a by a second SRS resource, e.g., SRS resource configured by SRS resource configuration 146, using beam 127 in a second direction to TRP 105 for the beam pair (beam 121, beam 127). Similarly, processor 131 can transmit simultaneously a SRS 111b by a first SRS resource, e.g., SRS resource configured by SRS resource configuration 152 or SRS resource configured by SRS resource configuration 144, using beam 123 in the first direction to TRP 103, and transmit a SRS 113b over a second SRS resource, e.g., SRS resource configured by SRS resource configuration 154 or SRS resource configured by SRS resource configuration 148, using beam 129 in the second direction to TRP 105 for the beam pair (beam 123, beam 129). Moreover, processor 131 can transmit SRSs by the one or more antenna beam pairs, such as (beam 121, beam 127), (beam 121, beam 129), (beam 123, beam 127), or (beam 123, beam 129) to TRP 103 and TRP 105, respectively.

In some embodiments, processor 131 can receive an indication of a selected antenna beam pair 116 from network node 101, where selected antenna beam pair 116 can be selected by network node 101 based on measured signal strength represented by Reference Signal Received Power (RSRP) or Signal to Interference plus Noise Ratio (SINR) for the SRSs, such as SRS 111a, SRS 111b, SRS 113a, or SRS 113b, transmitted by the one or more antenna beam pairs, such as (beam 121, beam 127), (beam 121, beam 129), (beam 123, beam 127), or (beam 123, beam 129). Afterwards, processor 131 can transmit data through Physical Uplink Shared Channel (PUSCH) by selected antenna beam pair 116 to the TRP 103 and TRP 105 simultaneously.

In some embodiments, processor 131 can determine an updated antenna beam pair 118 to replace selected antenna beam pair 116 for transmitting data through PUSCH by the updated antenna beam pair 118 to TRP 103 and TRP 105 simultaneously. In some embodiments, processor 131 can receive a message from network node 101 to instruct UE 102 to determine updated antenna beam pair 118, where the message is received after a timer 168 maintained by network node 101 is expired. In some embodiments, processor 131 can initiate a beam pair update process by sending an update message 119 to network node 101, where update message 119 can include a uplink control information (UCI) or a medium access control (MAC) control element (MAC-CE) message.

In some embodiments, network node 101 can include an antenna panel 175 that generates an antenna beam 177, a transceiver 173, a memory 172, and a processor 171 communicatively coupled to the transceiver. The transceiver can be configured to enable wireless communication with two TRPs, such as TRP 103 and TRP 105, and UE 102 in system 100. Network 101 can generate a number of SRS configuration sets, such as SRS configuration set 141, SRS configuration set 151, or more. The number of SRS configuration sets can include configurations for SRS resources for one or more antenna beam pairs, such as (beam 121, beam 127), (beam 121, beam 129), (beam 123, beam 127), or (beam 123, beam 129). The configurations for the SRS resources for the one or more antenna beam pairs can include a first configuration of a first SRS resource for the first beam, e.g., SRS resource configured by SRS resource configuration 142, and a second configuration of a second SRS resource for the second beam, e.g., SRS resource configured by SRS resource configuration 146. Together, SRS resource configured by SRS resource configuration 142 and SRS resource configured by SRS resource configuration 146 can form a pair 162 of SRS resources for an antenna beam pair, such as (beam 121, beam 127).

In some embodiments, network node 101 can transmit the number of SRS configuration sets, such as SRS configuration set 141, or SRS configuration set 151, to UE 102. In addition, network node 101 can measure the signal strength of SRSs. In some embodiments, network node 101 can receive indications of measured signal strength of SRSs, e.g., SRS 111a, SRS 111b, SRA 113a, SRS 113b, transmitted by the one or more antenna beam pairs received by TRP 103 and TRP 105. The indications of measured signal strength of SRSs can include a first signal strength indication for a first SRS, such as SRS 111a, and a second signal strength indication for a second SRS, such as SRS 113a, which can form SRS signal strengths of a beam pair 112. (Signal strength is indicated as “SS” in FIG. 1, e.g. 112 beam pair SRS SS) SRS 111a can be received by TRP 103 over SRS resource configured by SRS resource configuration 142 using beam 121 in the first direction determined by SRS spatial filter 147b that is configured by UE 102. SRS 113a can be received by TRP 105 over SRS resource configured by SRS resource configuration 146 using beam 127 in the second direction determined by SRS spatial filter 149b that is configured by UE 102. SRS 111a and SRS 113a can be transmitted simultaneously to TRP 103 and TRP 105, respectively. Similarly, network node 101 can receive or measure indications of measured signal strength of SRSs of a second beam pair 114.

In some embodiments, SRS signal strengths of beam pair 112 can include a first SRS signal strength for beam 1a, and a second SRS signal strength for beam 1b. Similarly, SRS signal strengths of beam pair 114 can include a first SRS signal strength for beam 2a, and a second SRS signal strength for beam 2b. SRS signal strengths for beam 1a, beam 1b, beam 2a, beam 2b, can be measured by RSRP or SINR.

In some embodiments, among the multiple measured signal strength of SRSs of beam pairs, such as measured signal strength of SRSs of beam pair 112, measured signal strength of SRSs of beam pair 114, or more, network node 101 can select antenna beam pair 116 based on the indications of measured signal strength of SRSs, such as SRS signal strength for beam 1a, SRS signal strength for beam 1b, SRS signal strength for beam 2a, SRS signal strength for beam 2b, and more. In some embodiments, to determine selected antenna beam pair 116, network node 101 can determine whether the first signal strength indication, e.g., SRS signal strength for beam 1a, or SRS signal strength for beam 1b, is larger than a first predetermined threshold value of measured signal strength 164, and determine whether a difference between the first signal strength indication and the second signal strength indication is smaller than a second predetermined threshold value 166. In some embodiments, first predetermined threshold value of measured signal strength 164 or second predetermined threshold value 166 can be pre-defined as a single value, or as a range of values and signaled by UE 102 and configured by the network node 101 through RRC signaling.

When there are multiple measured signal strength of SRSs of beam pairs satisfying the conditions in comparison with first predetermined threshold value of measured signal strength 164 or second predetermined threshold value 166, network node 101 may determine selected antenna beam pair 116 from the one or more antenna beam pairs based on a ranking of the indications of measured signal strength of SRSs for the one or more antenna beam pairs.

In some embodiments, when the SRS signal strength is represented by RSRP, SRS signal strength for beam 1a can be represented by RSRP_B1, and SRS signal strength for beam 1b can be represented by RSRP_B2. Network node 101 can rank the pairs, such as measured signal strength of SRSs of beam pair 112, measured signal strength of SRSs of beam pair 114, and more, based on sum of RSRP_B1 and RSRP_B2. Accordingly, the pair with the largest sum ranks first, then the pair with the second largest sum, and so forth. In some embodiments, the summation of RSRP_B1 and RSRP_B2 can be performed in linear or log manner. In some embodiments, network node 101 can rank the pairs based on the minimum value of (RSRP_B1, RSRP_B2), denoted as min (RSRP_B1, RSRP_B2), where the minimum is the lowest value of RSRP_B1 or RSRP_B2. Therefore, the pair with the largest min (RSRP_B1, RSRP_B2) ranks first, then the pair with the second largest min (RSRP_B1, RSRP_B2), and so forth. In some embodiments, network node 101 can rank the pairs based on the maximum of (RSRP_B1, RSRP_B2), denoted as max (RSRP_B1, RSRP_B2), where max (RSRP_B1, RSRP_B2) is the largest value of RSRP_B1 or RSRP_B2. Accordingly, the pair with the largest max (RSRP_B1, RSRP_B2) ranks first, then the pair with the second largest max (RSRP_B1, RSRP_B2), and so forth.

In some embodiments, when the SRS signal strength is represented by SINR, SRS signal strength for beam 1a can be represented by SINR_B1, and SRS signal strength for beam 1b can be represented by SINR_B2. Network node 101 can rank the pairs, such as measured signal strength of SRSs of beam pair 112, measured signal strength of SRSs of beam pair 114, and more, based on sum of SINR_B1 and SINR_B2. Accordingly, the pair with the largest sum ranks first, then the pair with the second largest sum, and so forth. In some embodiments, the ranking can be performed based on the sum of effectively channel capability, for example, log (1+SINR_B1)+log (1+SINR_B2). In some embodiments, the ranking can be performed based on the combination of RSRP representation and SINR representation.

In some embodiments, network node 101 can determine updated antenna beam pair 118 to replace selected antenna beam pair 116 for transmitting data through PUSCH by updated antenna beam pair 118 to TRP 103 and TRP 105 simultaneously.

In some embodiments, for each reported beam pair, there is a timer attached, such as timer 168. When the timer expires, network node 101 can consider the beam pair not valid or usable. The timer can be pre-defined in the specification, with one value or a range of values. Once the timer expires, network node 101 can initiate another group based beam reporting. UE 102 can also initiate a message to override the timer, if UE 102 thinks the current beam pair is still valid. The message to override the timer by UE 102 can be sent to network node 101 via RRC message, MAC CE, or UCI. In some embodiments, in periodic or semi-periodic group based reporting, the recent reported beam pair can override previously reported beam pair. If timer 168 is used, timer 168 can be reset.

In some embodiments, UE 102 can initiate a beam pair update by sending update message 119 to network node 101. Update message 119 for beam pair update can be considered as Uplink Control Information (UCI). In some embodiments, update message 119 can be considered as special Channel State Information (CSI) feedback. In terms of priority, update message 119 can have the same priority as existing CSI, for example, L1-RSRP or L1-SINR. In some embodiments, update message 119 can be considered as a new type of UCI, in addition to the existing SR/HARQ-ACK/CSI/CG-UCI messages. In some embodiments, update message 119 can be encoded standalone using polar code, or jointly encoded with other types of UCI using polar code.

In some embodiments, UE 102 can initiate a beam pair update by sending update message 119 to network node 101. Update message 119 for beam pair update can be sent via MAC-CE. If UE 102 already has UL grant for PUSCH transmission, UE 102 can transmit update message 119 as MAC-CE using the existing UL grant. If UE 102 does not have UL grant for PUSCH, one or both of the following user cases can be considered. In some embodiments, UE 102 can request UL grant via scheduling request (SR). Network node 101 can configure specific scheduling request resource dedicated for the purpose of UE beam pair update. This SR can have different or the same priority compared to the existing SR, during UCI multiplexing and collision handling. In some embodiments, network node 101 or UE 102 can use the existing SR. UE 102 can request UL grant via RACH procedure, such as Contention Free Random Access (CFRA), or Contention Based Random Access (CBRA).

In some embodiments, UE 102 may have the capability to support downlink group-based beam reporting or the SRS based beam selection. UE 102 may use the downlink group-based beam reporting or the SRS based beam selection for STxMP-based transmission. Network node 101 may configure UE 102 to make the selection through RRC or MAC CE message.

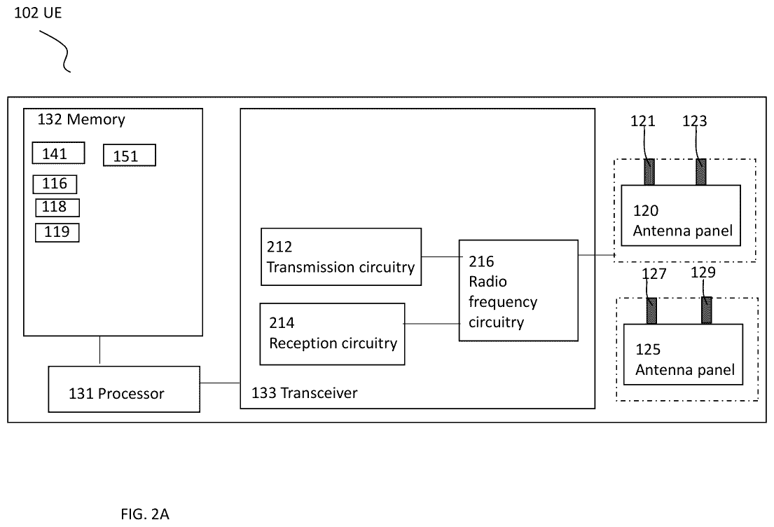

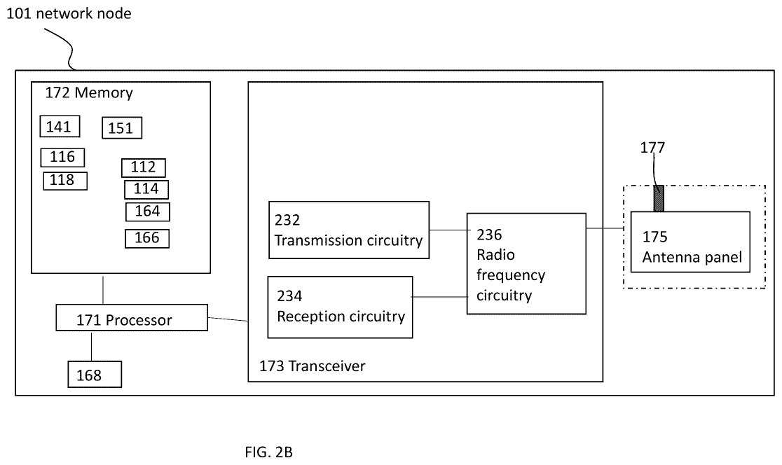

Referring to FIG. 2A, according to some aspects, UE 102 can be implemented according to a block diagram as illustrated in FIG. 2A. UE 102 can have an antenna system including antenna panel 120 and antenna panel 125 having one or more antenna elements to form various beams, e.g., beam 121, beam 123, beam 127, or beam 129, coupled to transceiver 133 and controlled by processor 131. Transceiver 133 and antenna panel 120 and antenna panel 125 can enable wireless communication in a wireless network, such as wireless system 100, including wireless communication with TRP 103 and TRP 105. In detail, transceiver 133 can include radio frequency (RF) circuitry 216, transmission circuitry 212, and reception circuitry 214 to enable wireless communication with other UEs and/or a base station as discussed for wireless system 100. RF circuitry 216 can include multiple parallel RF chains for one or more of transmit or receive functions, each connected to one or more antenna elements of the antenna panels. In addition, processor 131 can be communicatively coupled to memory 132, and transceiver 133. Various data can be stored in memory 132. In some examples, memory 132 can store SRS configuration set 141, SRS configuration set 151, selected antenna beam pair 116, updated beam pair 118, update message 119, as described for FIG. 1.

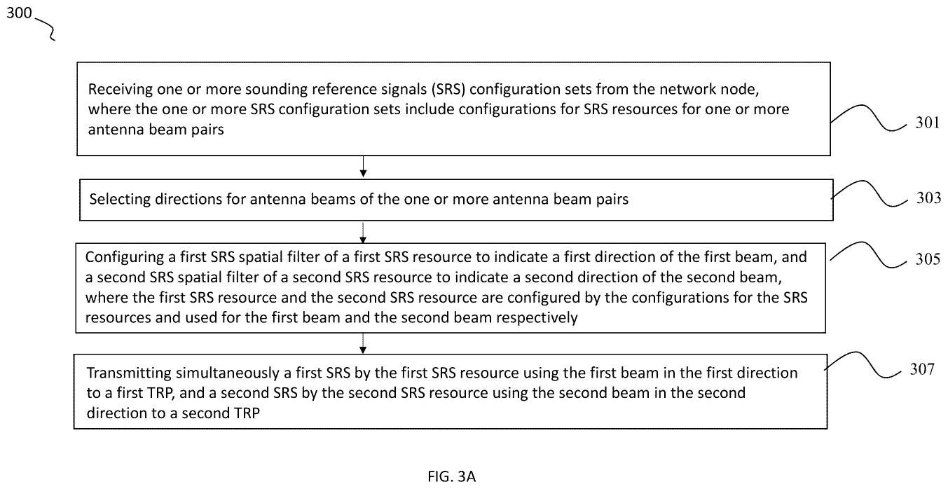

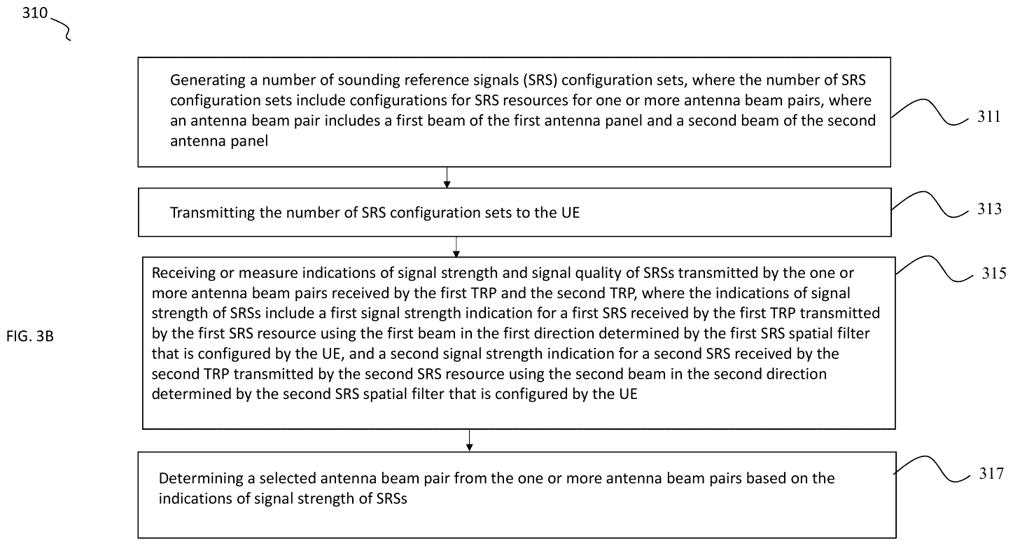

In some embodiments, memory 132 can store instructions, that when executed by processor 131 perform or cause to perform operations described herein, e.g., operations to supporting SRS based beam pair selection for STxMP. Alternatively, processor 131 can be “hard-coded” to perform the operations described herein. In some embodiments, processor 131 can be configured to perform operations described for FIG. 3A.

Referring to FIG. 2B, network node 101 can have antenna system including one or more antenna panel 175 to form various beams, e.g., beam 177, coupled to transceiver 173 and controlled by processor 171. Transceiver 173 and antenna panel 175 can enable wireless communication in a wireless network, such as wireless system 100, including wireless communication with UE 102. In detail, transceiver 173 can include radio frequency (RF) circuitry 236, transmission circuitry 232, and reception circuitry 234 to enable wireless communication with other UEs and/or a base station as discussed for wireless system 100. RF circuitry 236 can include multiple parallel RF chains for one or more of transmit or receive functions, each connected to one or more antenna elements of the antenna panel. In addition, processor 171 can be communicatively coupled to timer 168, memory 172, and the transceiver 173. Various data can be stored in memory 132. In some examples, memory 172 can store SRS configuration set 141, SRS configuration set 151, selected antenna beam pair 116, updated beam pair 118, SRS signal strengths of a first beam pair 112, signal strength of SRSs of a second beam pair 114, first predetermined threshold value of measured signal strength 164, second predetermined threshold value 166, as described for FIG. 1.

In some embodiments, memory 172 can store instructions, that when executed by processor 171 perform or cause to perform operations described herein, e.g., operations to support implementing SRS based beam pair selection for STxMP. Alternatively, processor 171 can be “hard-coded” to perform the operations described herein. In some embodiments, processor 171 can be configured to perform operations described for FIG. 3B.

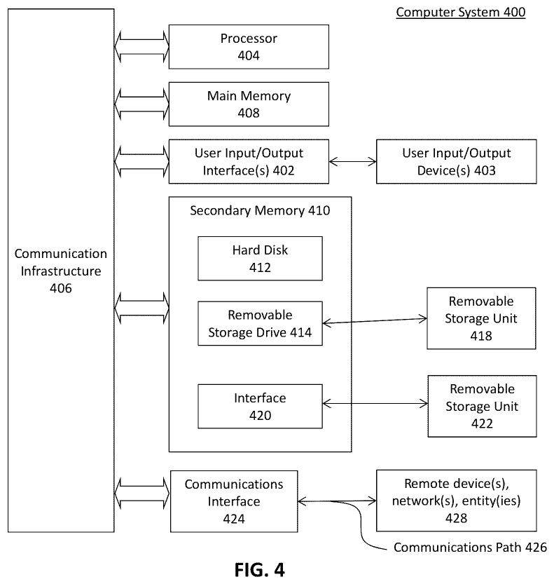

FIG. 3A illustrates an example process 300 performed by UE 102 supporting SRS based beam pair selection for STxMP, according to some aspects of the disclosure. Process 300 can be performed by UE 102, which may be implemented as shown in FIG. 2A. For example, process 300 can be performed, or cause to performed, by processor 131 in conjunction with other elements of UE 102, and/or a computer system 400 of FIG. 4. Process 300 is not limited to the specific aspects depicted in those figures and other systems may be used to perform the method as will be understood by those skilled in the art. It is to be appreciated that not all operations may be needed, and the operations may not be performed in the same order as shown in process 300.

At 301, UE 102 can receive one or more SRS configuration sets, such as SRS configuration set 141, or SRS configuration set 151, from network node 101. The one or more SRS configuration sets can include configurations for SRS resources for one or more antenna beam pairs, such as beam pairs comprising: (beam 121, beam 127), (beam 121, beam 129), (beam 123, beam 127), and (beam 123, beam 129), where an antenna beam pair includes a first beam of the first antenna panel and a second beam of the second antenna panel.

At 303, UE 102 can select directions for antenna beams of the one or more antenna beam pairs. For example, one or more antenna beams can be directed at TRP 103 and/or TRP 105 in FIG. 1.

At 305, UE 102 can configure a first SRS spatial filter for a first SRS resource to determine a first direction of the first beam, and a second SRS spatial filter for a second SRS resource to determine a second direction of the second beam, where the first SRS resource and the second SRS resource are configured by the configurations for the SRS resources and used for the first beam and the second beam respectively. For example, processor 131 can configure SRS spatial filter 147a for a SRS resource configured by SRS resource configuration 142 to become SRS spatial filter 147b to determine a first direction of beam 121, and configure SRS spatial filter 149a for a SRS resource configured by SRS resource configuration 146 to become SRS spatial filter 149b to determine a second direction of beam 127, where the SRS resource configured by SRS resource configuration 142 and the SRS resource configured by SRS resource configuration 146 are configured by the configurations for the SRS resources and used for beam 121 and beam 127 respectively.

At 307, UE 102 can transmit simultaneously SRS 111a by the SRS resource configured by SRS resource configuration 142 using beam 121 in the first direction to TRP 103, and SRS 113a by the SRS resource configured by SRS resource configuration 146 using beam 127 in the second direction to TRP 105.

FIG. 3B illustrates an example process 310 performed by network node 101 supporting SRS based beam pair selection for STxMP, according to some aspects of the disclosure. Process 310 can be performed by network node 101, which may be implemented as shown in FIG. 2B. For example, process 310 may be performed, or cause to be performed, by processor 171 of network node 101 in conjunction with other elements of network node 101, and/or a computer system 400 of FIG. 4. Process 310 is not limited to the specific aspects depicted in those figures and other systems may be used to perform the method as will be understood by those skilled in the art. It is to be appreciated that not all operations may be needed, and the operations may not be performed in the same order as shown in process 310.

At 311, network node 101 can generate a number of SRS configuration sets, such as SRS configuration set 141, SRS configuration set 151, or more. The number of SRS configuration sets can include one SRS configuration set, two SRS configuration sets, or more. The number of SRS configuration sets can include configurations for SRS resources for one or more antenna beam pairs, such as beam pairs comprising: (beam 121, beam 127), (beam 121, beam 129), (beam 123, beam 127), and (beam 123, beam 129).

At 313, network node 101 can transmit the number of SRS configuration sets to UE 102.

At 315, network node 101 can receive or measure indications of signal strength (RSRP) and signal quality (SINR) of SRSs transmitted by the one or more antenna beam pairs received by TRP 103 and 105, where the indications of signal strength of SRSs include a first signal strength indication for a first SRS received by the first TRP transmitted over the first SRS resource using the first beam in a first direction determined by a first SRS spatial filter that is configured by the UE, and a second signal strength indication for a second SRS received by the second TRP transmitted over the second SRS resource using the second beam in a second direction determined by a second SRS spatial filter that is configured by the UE, wherein the first SRS and the second SRS are transmitted simultaneously to the first TRP and the second TRP, respectively. For example, network node 101 can receive SRS signal strength for beam 1a, and SRS signal strength for beam 1b, represented as beam pair SRS SS 112 in FIG. 1. SRS signal strength for beam 1a can be received by TRP 103 transmitted over SRS resource configured by SRS resource configuration 142 using beam 121 in a first direction determined by SRS spatial filter 147b that is configured by UE 102. SRS signal strength for beam 1b can be received by TRP 105 transmitted over SRS resource configured by SRS resource configuration 146 using beam 127 in a second direction determined by SRS spatial filter 149b that is configured by UE 102. A similar construct exists for beam pair SRS SS 114 as described above.

At 317, network node 101 can select antenna beam pair 116 from the one or more antenna beam pairs, such as beam pairs (beam 121, beam 127), (beam 121, beam 129), (beam 123, beam 127), (beam 123, beam 129). Antenna beam pair 116 can be selected based on the indications of signal strength of SRSs, such as measured signal strength of SRSs of beam pair 112, measured signal strength of SRSs of beam pair 114, or more. In some embodiments, measured signal strength of SRSs of beam pair 112 or measured signal strength of SRSs of beam pair 114 can be represented by a RSRP or a SINR.

Various aspects can be implemented, for example, using one or more computer systems, such as computer system 400 shown in FIG. 4. Computer system 400 can be any computer capable of performing the functions described herein such as UE 102 or network node 101 in FIG. 1, for operations described for process 300 or process 310. Computer system 400 includes one or more processors (also called central processing units, or CPUs), such as a processor 404. Processor 404 is connected to a communication infrastructure 406 (e.g., a bus). Computer system 400 also includes user input/output device(s) 403, such as monitors, keyboards, pointing devices, etc., that communicate with communication infrastructure 406 through user input/output interface(s) 402. Computer system 400 also includes a main or primary memory 408, such as random access memory (RAM). Main memory 408 may include one or more levels of cache. Main memory 408 has stored therein control logic (e.g., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 reads from and/or writes to removable storage unit 418 in a well-known manner.

According to some aspects, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 408, the removable storage unit 418, the removable storage unit 422 can store instructions that, when executed by processor 404, cause processor 404 to perform operations for a UE, UE 102 or network node 101 in in FIG. 1, for operations described for process 300 or process 310.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 426, which may be wired and/or wireless, and which may include any combination of LANs, WANs, the Internet, etc. Control logic and/or data may be transmitted to and from computer system 400 via communication path 426.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 400, main memory 408, secondary memory 410 and removable storage units 418 and 422, as well as tangible articles of manufacture embodying any combination of the foregoing. Such control logic, when executed by one or more data processing devices (such as computer system 400), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 4. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

For one or more embodiments or examples, at least one of the components set forth in one or more of the preceding figures may be configured to perform one or more operations, techniques, processes, and/or methods as set forth in the example section below. For example, circuitry associated with a UE, base station, network element, etc. as described above in connection with one or more of the preceding figures may be configured to operate in accordance with one or more of the examples set forth below in the example section.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE), comprising:
a transceiver, coupled to a first antenna panel and a second antenna panel, and configured to enable wireless communication with two transmission reception points (TRPs) and a network node in a wireless communication system; and
a processor communicatively coupled to the transceiver and configured to:
receive one or more sounding reference signals (SRS) configuration sets from the network node, wherein the one or more SRS configuration sets include configurations for SRS resources for one or more antenna beam pairs, wherein an antenna beam pair includes a first beam of the first antenna panel and a second beam of the second antenna panel;
select directions for antenna beams of the one or more antenna beam pairs;
configure a first SRS spatial filter for a first SRS resource to determine a first direction of the first beam, and a second SRS spatial filter for a second SRS resource to determine a second direction of the second beam, wherein the first SRS resource and the second SRS resource are configured by the configurations for the SRS resources and used for the first beam and the second beam respectively; and
transmit simultaneously a first SRS by the first SRS resource using the first beam in the first direction to a first TRP, and a second SRS by the second SRS resource using the second beam in the second direction to a second TRP.

2. The UE of claim 1, wherein the one or more SRS configuration sets include one or more parameters including a SRS-ResourceSet, and the first SRS spatial filter is associated with a parameter spatialRelationInfo included within the SRS-ResourceSet.

3. The UE of claim 1, wherein the first SRS spatial filter for the first SRS resource or the second SRS spatial filter for the second SRS resource is associated with a parameter included in the one or more SRS configuration sets, and wherein the processor is further configured to change the parameter from a first value to a second value to configure the first SRS spatial filter.

4. The UE of claim 1, wherein the SRS resources for the one or more antenna beam pairs are included in one SRS configuration set determined by the network node.

5. The UE of claim 1, wherein the processor is further configured to:
determine the first SRS resource for the first beam from a first group of SRS resources configured by a first SRS configuration set received from the network node; and
determine the second SRS resource for the second beam from a second group of SRS resources configured by the first SRS configuration set, wherein the first group of SRS resources is different from the second group of SRS resources.

6. The UE of claim 1, wherein the processor is further configured to:
determine the first SRS resource for the first beam configured by a first SRS configuration set received from the network node; and
determine the second SRS resource for the second beam configured by a second SRS configuration set received from the network node, wherein the second SRS configuration set is different from the first SRS configuration set.

7. The UE of claim 6, wherein the first SRS configuration set and the second SRS configuration set are configured for a same uplink transmission usage.

8. The UE of claim 1, wherein the processor is further configured to:
transmit SRSs by the one or more antenna beam pairs to the first TRP and the second TRP respectively;
receive an indication of a selected antenna beam pair from the network node, wherein the selected antenna beam pair is selected by the network node based on a measured signal strength represented by Reference Signal Received Powers (RSRPs) or Signal to Interference plus Noise Ratios (SINRs) for the SRSs transmitted by the one or more antenna beam pairs; and
transmit data through a Physical Uplink Shared Channel (PUSCH) by the selected antenna beam pair to the first TRP and the second TRP, simultaneously.

9. The UE of claim 8, wherein the processor is further configured to:
determine an updated antenna beam pair to replace the selected antenna beam pair for transmitting data through the PUSCH by the updated antenna beam pair to the first TRP and the second TRP simultaneously.

10. The UE of claim 9, wherein the processor is further configured to:
receive a message from the network node to instruct the UE to determine the updated antenna beam pair, wherein the message is received after a timer maintained by the network node is expired.

11. The UE of claim 9, wherein the processor is further configured to:
initiate a beam pair update process by sending an update message to the network node, wherein the update message includes a uplink control information (UCI) or a medium access control (MAC) control element (MAC-CE) message.

12. A network node, comprising:
a transceiver configured to enable wireless communication with two transmission reception points (TRPs) and a user equipment (UE) in a wireless communication system, the UE having a first antenna panel and a second antenna panel; and
a processor communicatively coupled to the transceiver and configured to:
generate a number of sounding reference signals (SRS) configuration sets, wherein the number of SRS configuration sets include configurations for SRS resources for one or more antenna beam pairs, wherein an antenna beam pair includes a first beam of the first antenna panel and a second beam of the second antenna panel, the configurations for the SRS resources for the one or more antenna beam pairs include a first configuration of a first SRS resource for the first beam, and a second configuration of a second SRS resource for the second beam;
transmit the number of SRS configuration sets to the UE; and
receive or perform a measurement of indications of signal strength of SRSs transmitted by the one or more antenna beam pairs received by the first TRP and the second TRP, wherein the indications of signal strength of SRSs include a first signal strength indication for the first SRS received by the first TRP transmitted over the first SRS resource using the first beam in a first direction determined by a first SRS spatial filter that is configured by the UE, and a second signal strength indication for a second SRS received by the second TRP transmitted over the second SRS resource using the second beam in a second direction determined by a second SRS spatial filter that is configured by the UE.

13. The network node of claim 12, wherein the first signal strength indication is represented by a Reference Signal Received Power (RSRP) or a Signal to Interference plus Noise Ratio (SINR) for the first SRS received by the first TRP transmitted over the first SRS resource using the first beam in the first direction.

14. The network node of claim 12, wherein the processor is further configured to:
select an antenna beam pair from the one or more antenna beam pairs based on the indications of signal strength of SRSs, wherein the first signal strength indication or the second signal strength indication is represented by a Reference Signal Received Power (RSRP) or a Signal to Interference plus Noise Ratio (SINR).

15. The network node of claim 14, wherein to determine the selected antenna beam pair, the processor is further configured to:
determine whether the first signal strength indication or the second signal strength indication is larger than a predetermined threshold value of signal strength.

16. The network node of claim 15, wherein the predetermined threshold value of signal strength is a first predetermined threshold value, and the processor is further configured to:
determine whether a difference between the first signal strength indication and the second signal strength indication is smaller than a second predetermined threshold value.

17. The network node of claim 14, wherein to determine the selected antenna beam pair, the processor is further configured to:
determine the selected antenna beam pair from the one or more antenna beam pairs based on a ranking of the indications of signal strength of SRSs for the one or more antenna beam pairs.

18. The network node of claim 14, wherein the processor is further configured to:
determine an updated antenna beam pair to replace the selected antenna beam pair for transmitting data through a PUSCH by the updated antenna beam pair to the first TRP and the second TRP simultaneously.

19. The network node of claim 12, wherein the number of SRS configuration sets include one SRS configuration set having a first group of SRS resources and a second group of SRS resources, and the SRS resources for the one or more antenna beam pairs include the first SRS resource for the first beam selected from the first group of SRS resources, and the second SRS resource for the second beam selected from the second group of SRS resources.

20. The network node of claim 12, wherein the number of SRS configuration sets include two SRS configuration sets, and the SRS resources for the one or more antenna beam pairs include the first SRS resource for the first beam selected from a first SRS configuration set, and the second SRS resource for the second beam selected from a second SRS configuration set.
